(19) United States
(12) Patent Application Publication
(10) Pub. No.: US 2026/0019016 A1
(43) Pub. Date: Jan. 15, 2026

(54) PULSE WIDTH MODULATION EXCITATION FOR MAGNETIC FIELDS FOR HYDROELECTRIC APPLICATIONS

(71) Applicant: Eagle Creek Renewable Energy, LLC, Bethesda, MD (US)

(72) Inventors: Walter John Simmons, Martinsburg, WV (US); Walter Neal Simmons, Bahama, NC (US); Roy Jones, Hagerstown, MD (US)

(21) Appl. No.: 19/050,097

(22) Filed: Feb. 10, 2025

Related U.S. Application Data
(60) Provisional application No. 63/551,526, filed on Feb. 8, 2024.

(51) Int. Cl. H02P 9/14

(52) U.S. Cl. CPC H02P 9/14

(57) ABSTRACT

A method of controlling synchronous generator exciter magnetic fields at a hydroelectric facility includes controlling field strength of a generator exciter by using pulse-width-modulation with at least one dual IGBT module. A PWM frequency of each IGBT module may be sufficient such that during an off time thereof, a magnetic field of the generator exciter does not drop more than 20%.

### CROSS-REFERENCE TO RELATED APPLICATIONS

This application claims the benefits of U.S. Provisional Application No. 63/551,526 filed Feb. 8, 2024 by Walter John Simmons, Walter Neal Simmons, and Roy Jones and entitled “Pulse Width Modulation Excitation for Magnetic Fields for Hydroelectric Applications” under 35 U.S.C. § 119(e) and the entire contents of that application are expressly incorporated herein by reference thereto.

### FIELD OF THE INVENTION

The invention relates to a method of controlling synchronous generator exciter magnetic fields at a hydroelectric facility includes controlling field strength of a generator exciter by using pulse-width-modulation with at least one dual IGBT module. A PWM frequency of each IGBT module may be sufficient such that during an off time thereof, a magnetic field of the generator exciter does not drop more than 20%.

### BACKGROUND OF THE INVENTION

Hydroelectric synchronous generators installed from the late 1800s to mid-1900s used either motor generators or, more recently, diode rectifiers to provide direct current (DC) to the field windings of the generator. In modern times, many of these hydroelectric generators still use originally installed motor generators or diode rectifiers optionally with large rheostats to control the magnetic fields in the generators. The strength of the field needs to be regulated to control output voltage and revolutions per minute (RPM) for synchronization during startup and generator output when connected to the grid. Large variable resistors (rheostats) have been used for this purpose, but substantial power is wasted by using them; all current flowing through the rheostats wastes power measured by the amperage squared times the resistance. The rheostats are controlled manually or, in more recent times. by a motor that drives the position of the rheostat. Another more expensive retrofit is to upgrade to a diode rectifier bridge with alternating current (AC) power to the bridge controlled by either a phase angle thyristor or time fired thyristor on the AC power into the bridge rectifier. Because the input AC frequency is 50 or 60 hertz even when rectified, significant AC ripple remains on the exciter field. If fed by single phase, the frequency of the ripple is 120 Hz. If supplied by a three phase bridge, the ripple is 360 Hz. The ripple component wastes energy and also produces audible noise in the normal hearing range.

The prior art systems thus suffer from numerous disadvantages. Among the disadvantages are low efficiency associated with motor generators, low efficiency associated with all rheostat systems, and audible noise from thyristor-controlled systems in the 120 to 360 Hz range (although at 60 Hz if only one diode is used). Another disadvantage is a loss of efficiency of the magnetic field in the generator from the low frequency change in magnetic field. Yet another disadvantage is that the output waveform has noise from the change in magnetic field (desirable performance and efficiency is obtained instead when the magnetic field does not change and a matching sine wave is formed).

Even new, commercially available exciter controllers suffer from the aforementioned problems with audible noise, loss of efficiency of the magnetic field, and a noisy output waveform. Problematically, they also are very expensive, precluding their use in most applications.

An additional problem in many hydroelectric facilities is that they have limited or no automation. As a result, it is challenging to employ commercial exciter systems that use ethernet or commercial communication protocols.

“Pulse width modulation (PWM) is a modulation technique that generates variable-width pulses to represent the amplitude of an analog input signal. The output switching transistor is on more of the time for a high-amplitude signal and off more of the time for a low-amplitude signal. The digital nature (fully on or off) of the PWM circuit is less costly to fabricate than an analog circuit that does not drift over time.” Robert D. Christ and Robert L. Wernli, Sr., The ROV Manual. A User Guide for Remotely Operated Vehicles, Second Edition, Butterworth-Heinemann, Oxford, UK, 2014, at 160. The “on” time of the square wave signal is adjusted, i.e., modulated. PWM is used, for example, to control motors, and generates square-wave pulses of different widths. PWM permits the average amount of power delivered to a load or the output to be controlled.

An Insulated-Gate Bipolar Transistor (IGBT) is a solid state, power electronic device that may be used to switch high voltage and high currents very quickly. For example, an IGBT can switch at a frequency of 100,000 cycles per second. “The most basic function of an IGBT is the fastest possible switching of [large] electric currents, thus achieving the lowest possible switching losses. As the name ‘Insulated Gate Bipolar Transistor’ reveals, an IGBT is a bipolar transistor with an isolated gate structure; the gate itself is basically a MOSFET. Therefore, the IGBT combines the advantages of high current-carrying capabilities and high blocking voltages of a bipolar transistor with the capacitive, almost zero-power based control of a MOSFET.” Martin Schulz, IGBT-basic know-how. IGBT: how does an Insulated Gate Bipolar Transistor work?, v1.0, Infineon Technologies AG, Munich, Germany, November 2019. IGBTs are relatively inexpensive and used in such technologies as wind energy, solar energy, and automobiles. See also Solutions for Wind Energy Systems. Energy-efficient components and subsystems for high system reliability, Infineon Technologies AG, Neubiberg, Germany, April 2013; Wibawa Chou, Choose Your IGBTs Correctly for Solar Inverter Applications, Power Electronics Technology, August 2008, at 20 (“For solar inverter applications, it is well known that insulated-gate bipolar transistors (IGBTs) offer benefits compared to other types of power devices, like high-current-carrying capability, gate control using voltage instead of current and the ability to match the co-pack diode with the IGBT.”).

There exists a need for high-frequency exciters for use in hydroelectric facilities that operate at a significantly elevated frequency compared to conventional technology. There also exists a need for improved performance and reliability with respect to the speed and accuracy at which the excitation voltage responds to the change of the regulated voltage during steady and dynamic loading of a generator. There further exists a need for exciter technology that utilizes fast switching speeds of IGBT technology commonly used in converters for electric-motor drives especially to achieve power savings. In addition, there exists a need for a method of controlling reactive power that does not suffer disadvantages of the prior art and a method for controlling direct current field voltage by changing PWM having a period in the sub-millisecond range.

### SUMMARY OF THE INVENTION

An exemplary method of controlling synchronous generator exciter magnetic fields at a hydroelectric facility includes: controlling field strength of a generator exciter by using pulse-width-modulation with at least one dual IGBT module selected from the group of: (i) a dual IGBT module comprising an unswitched IGBT and a switched IGBT connected in series with each other; and (ii) two single IGBT modules connected in series, the first module comprising an unswitched IGBT and the second module comprising a switched IGBT, the unswitched IGBT and the switched IGBT connected in series with each other; wherein a single IGBT module is selected from the group of: (i) two single IGBT modules, (ii) two double IGBT modules, (iii) two triple IGBT modules, and (iv) a single dual IGBT module; wherein each unswitched and switched IGBT comprises a collector, an emitter, and a gate; wherein a pulse-width modulator supplies switching voltage to the gate; wherein each unswitched and switched IGBT is connected in parallel with a freewheeling diode; wherein each IGBT module has a sub-millisecond period, an on-off switching time and an off-on switching time each being no more than 10 μs, and a PWM frequency of 100 Hz to 30,000 Hz; wherein the generator exciter is supplied with a total current of at least 50 A from the at least one dual IGBT module.

In some embodiments, the PWM frequency may be sufficient such that during an off time thereof, a magnetic field of the generator exciter does not drop more than 20%. The PWM frequency may be sufficient such that during the off time thereof, the magnetic field of the generator exciter does not drop more than 10%. In some embodiments, the PWM frequency may be sufficient such that during an on time thereof, a magnetic field of the generator exciter does not increase more than 20%. The PWM frequency may be sufficient such that during the on time thereof, the magnetic field of the generator exciter does not increase more than 10%. The PWM frequency may be sufficient such that during the on time thereof, the magnetic field of the generator exciter does not increase more than 2%.

A gate signal from the pulse-width modulator to the switched IGBT may have a gate-to-emitter voltage between 8 V and 20 V and the gate signal may supply 0.5A to 20 A between the gate and the emitter at a frequency of 500 to 30,000 Hz. A gate signal from the pulse-width modulator to the switched IGBT may have a gate-to-emitter voltage between 12 V and 15 V and the gate signal may supply 0.5A to 20 A between the gate and the emitter at a frequency of 500 to 30,000 Hz. The gate of the unswitched IGBT may be shorted to the emitter thereof to prevent switching. A high frequency pulse-width modulated current may be used to drive a magnetic field of the generator exciter.

The frequency range of the pulse-width modulation may be from 500 Hz to 30,000 Hz. Pulse-width modulated on time may be from 20% to 80%. The exciter current may be from 50 to 500 amps. The exciter voltage may be between 50 and 500 volts. The output of the generator may be from 0.1 MW to 50 MW.

The exciter frequency and PWM on time may be matched to an impedance of the generator. The frequency range of the pulse-width modulation may be from 1 kHz to 20 kHz. The exciter input voltage may be selected to provide pulse-width modulation on times from 30% to 60%. The pulse-width modulation frequency may be above audible range for humans. The pulse-width modulation frequency may be above 15 kHz.

In some embodiments, generator coils and exciter pole pieces may not vibrate in the audible range for humans. Maximum voltage overshoot and undershoot may be below ionization voltage. The maximum voltage overshoot and undershoot may be below 350 volts.

Capacitors connected in parallel to the input bus may provide capacitance to keep voltage overshoot and undershoot below ionization voltage.

The voltage and current rating of the freewheeling diode may be about equal to the rating of the IGBTs.

Voltage drop across the freewheeling diode may be about equal voltage drop across the switched IGBT when it is switched on. The voltage rating of the IGBT is at least 5 times the operating voltage of the generator exciter. The frequency of the pulse-width modulation may be sufficient to provide a maximum change in exciter current during the pulse-width modulation on time of no more than 10%.

The frequency of the pulse-width modulation may be sufficient to provide a maximum change in exciter current during the pulse-width modulation on time of no more than 5%. The frequency of the pulse-width modulation may be sufficient to provide a maximum change in exciter current during the pulse-width modulation off time of no more than 10%. The frequency of the pulse-width modulation may be sufficient to provide a maximum change in exciter current during the pulse-width modulation off time of no more than 5%.

Another exemplary method of controlling synchronous generator exciter magnetic fields at a hydroelectric facility includes: controlling field strength of a generator exciter by using pulse-width-modulation with at least one IGBT module selected from the group of: (i) a dual switch, half-bridge IGBT module comprising an unswitched IGBT and a switched IGBT in series; and (ii) two IGBT modules connected in series to form a half-bridge, the first module comprising an unswitched IGBT and the second module comprising a switched IGBT, each unswitched and switched IGBT connected in parallel with a freewheeling diode; wherein each unswitched and switched IGBT comprises a collector, an emitter, and a gate; wherein each unswitched and switched IGBT is connected in parallel with a freewheeling diode; wherein the frequency of pulse-width modulation is sufficient to provide a maximum change in exciter current during each of PWM on and PWM off time of no more than 10%.

The frequency of pulse-width modulation may be sufficient to provide a maximum change in exciter current during each of the PWM on and PWM off time of no more than 5%. The frequency of pulse-width modulation may be sufficient to provide a maximum change in generator exciter current during the PWM on time of no more than 10%. The frequency of pulse-width modulation may be sufficient to provide a maximum change in generator exciter current during the PWM on time of no more than 5%. The frequency of pulse-width modulation may be sufficient to provide a maximum change in generator exciter current during the PWM on time of no more than 2%. The frequency of pulse-width modulation may be sufficient to provide a maximum change in generator exciter current during the PWM off time of no more 10%. The frequency of pulse-width modulation may be sufficient to provide a maximum change in generator exciter current during the PWM off time of no more 5%. The frequency of pulse-width modulation may be sufficient to provide a maximum change in generator exciter current during the PWM off time of no more 2%. Pulse-width modulation current may be operating at a frequency and PWM on time to produce at least 10% savings in power at zero KVARS phase angle thyristor or time fired thyristor exciter controllers operating at 50 A to 500 A.

An exemplary controller for a hydroelectric facility for controlling synchronous generator exciter field strength includes: at least one IGBT module selected from the group consisting of: (i) a dual switch, half-bridge IGBT module comprising an unswitched IGBT and a switched IGBT in series; and (ii) two IGBT modules connected in series to form a half-bridge, the first module comprising an unswitched IGBT and the second module comprising a switched IGBT, each unswitched and switched IGBT connected in parallel with a freewheeling diode; wherein each unswitched and switched IGBT is connected in parallel with a freewheeling diode; a pulse-width generator that provides a pulse width frequency and pulse width modulation percent on signal, wherein the pulse width modulation percent on signal has a frequency of 500 Hz to 30,000 Hz and switches the switched IGBT of the at least one IGBT module.

An inventive embodiment relates to high-frequency exciters that operate at a significantly elevated frequency compared to conventional technology. Such advanced exciters harness the benefits of: 1) enhanced power conversion efficiency attainable from Insulator-Gate Bipolar Transistors (IGBT) semiconductors; and 2) a compact design approach that reduces the system's footprint. Increased efficiency materially reduces exciter operating costs by requiring less electric consumption relative to a conventional exciter. The reduction of the operational footprint results in reduced installation, operational, and maintenance costs (reduced number of components that can fail) while improving reliability throughout the equipment's life span. The unique features of the innovative exciter technology lie in the utilization of semi-conductors, which have recently become available at affordable prices due to mass production and increased availability driven by the electric vehicle, wind, and solar industries. Semiconductors unlock the potential for higher frequencies, with the attendant benefits described above.

An inventive embodiment of exciter technology operates on the principle of utilizing fast switching speeds of IGBT technology commonly used in converters for electric-motor drives to provide better performance and reliability with the speed and accuracy at which the excitation voltage responds to the change of the regulated voltage during steady and dynamic loading of the generator. These attributes make the proposed design perform far better than traditional systems such as thyristor-based control systems. Although the objective for both the IGBT-controlled system and the traditional systems is to provide and maintain voltage at the generator terminals under different regulation, the combined features of the IGBT (high switching MOSFETS and high current handling BJTs) design package in the H-Bridge excitation system design produces faster excitation power buildup to the generator terminals all while maintaining excellent energy conservation and environmental protection.

An inventive embodiment of an exciter design integrates all functions of traditional models including interface with input power section from the excitation transformer (PPT), interface hardware for protection, control and monitoring, and output DC current to the generator terminals. However, due to inherent benefits of IGBT technology, 100% of continuous pulse-width modulated DC output is reached and maintained within milliseconds thereby significantly reducing reliance of field flashing equipment.

When the system experiences anomalies requiring the exciter to trip, the inherently fast-acting design feature of IGBTs together with the proposed advanced excitation regulation results in ultra-fast halt of gating the IGBT such that current in the field is expeditiously collapsed into the DC link capacitor circuit. The rapid response enhances longer equipment life span.

Advantageously, an inventive embodiment of a system uses high-frequency exciters driven by the mass production and availability of semiconductors from the electric vehicle industry. Because of the widespread implementation in the electric vehicle industry, reduced pricing of IGBT packages allows power conversion in excitation systems. In the inventive system, such semiconductors may be used in a scalable (e.g., 50-3600 A) manner for power conversion in order to optimize excitation system performance.

An inventive embodiment of an exciter advantageously improves performance and decreases the average footprint of the system by more than 70% due to compact design. In one embodiment, an inventive system comprises only one (1) cabinet as small as 24×24×8 inches deep to compactly house hardware that supports system functionality. In another embodiment, four (4) standard cabinet enclosures (32×82×32 inch) are used. In yet another embodiment, one (1) standard cabinet enclosure is used (e.g., 36×48×10 inch). The system may be disposed in a single standard cabinet to house the required hardware. Furthermore, the inventive system only requires low input power to produce large, controlled currents, thereby resulting in a significant reduction in size (electrical and footprint) of power potential transformers (PPT) that power the rectification circuitry.

An inventive embodiment of an exciter footprint provides substantial cost reduction over the system's life span. During installation and commissioning, the installation schedule is significantly reduced due to fewer components in the system. Operation and maintenance (preventative and corrective) costs also are reduced due to the use of fewer components. Such a compact design results in low maintenance requirements, while its high efficiency and rapid response time reduces power consumption.

Still further, an inventive embodiment of a high-frequency exciter is scalable to fit low-to-medium excitation systems (20 A to 3600 A) without additional footprint. In some embodiments, power conversion packages of 1400 A through 3600 A may have the same dimensions.

The target performance of an inventive embodiment of exciter technology is to improve the efficiency of the excitation process by 40%, thereby reducing energy consumption, operational costs, and downtime (system outage due to install and maintenance). A notable increase in excitation efficiency may be realized, contributing to enhanced overall hydroelectric performance. In one exemplary, 51.2 MW dispatchable peaking hydroelectric facility equipped with four Francis turbine units connected to four generators, the reduction in estimated power losses purely due to switching from a thyristor-based excitor to an IGBT-based excitation system is roughly $33k/year while maintenance costs (including repairs) would be close to $600 k spread across 4 units and spare inventory.

The existing state of exciter technology in hydroelectric facilities often relies on a slow response thyristor rectifier bridge for direct (static) excitation modules with lower frequencies to provide a somewhat continuous DC current to the field winding of the synchronous generator through a closed-loop feedback control. The exciter systems are inherently large in size due to the size of the thyristor bridges, cooling requirements, and auxiliary hardware for functionality of complex voltage regulation circuitry. The bridge consists of the thyristor stack, firing cards, and necessary equipment for monitoring. While functional, these exciters may incur higher electrical service requirements for excitation maintenance.

Advantageously, the IGBT-based system outperforms the existing systems in building generator voltage and maintaining it through dynamic loading as imposed by the grid.

An inventive system overcomes these shortcomings by introducing a paradigm shift in exciter design, utilizing IGBT technology to enable higher frequencies, lower conduction losses, and faster switching. The increased frequency results in a smoothly regulated excitation current in all modes of system operation. The system's compact design provides a reduced footprint, a scalable platform that meets different generator demands, and smooth maintenance of excitation at the terminals through dynamic loading as imposed by the grid. Leveraging the advancements in semiconductor production driven by the electric vehicle industry addresses limitations and facilitates the development of a more sustainable and cost-effective solution.

Alternatively, with built-in controllers, low cost Arduino PWM H-bridge IGBTs may be used, e.g., to control 100 A at frequencies, e.g., from 100 to 30,000 Hz in some embodiments and from 0 to 20,000 Hz in other embodiments.

Implementation of an inventive system in hydroelectric facilities significantly impact the field by enhancing overall system efficiency, reducing operational costs, and contributing to the sustainability of hydroelectric power generation.

There is a need for a scalable platform to support different generator sizes without substantially changing the footprint of the system. An integral part of the inventive exciter technology is that the advanced excitation is designed to work with the high frequency system to maintain the required voltage on the generator terminals with built-in protection functions.

One phenomenon expected from high frequency semiconductor switching in inductive loads is the presence of electrical magnetic interferences. As required by industry standards such as EN 61000 series, compliance testing is required for both conducted and radiated emissions to ensure safe operation of the system.

An exemplary inventive embodiment may use IGBTs with freewheeling diodes to providing variable magnetic fields for use in hydroelectric generators. The frequency range may be from 500 to 30,000 Hz. The PWM “on” time may be 20% to 80% (“off” time 80% to 20%). The exciter current may be from 50 to 500 amps. The exciter voltage may be from 50 and 500 volts. The output of the generator may be from 100 kw to 50,000 kw. The exciter frequency and PWM “on” time may be matched to the generator's impedance to provide maximum magnetic field for the minimum power. The frequency range preferably may be from 1,000 to 20,000 Hz. The exciter input voltage may be changed to provide PWM “on” times from 30% to 60%. The PWM frequency may be above audible range for humans, such as 15,000 Hz. The PWM frequency may be above that which produces audible noise from the generator coils or pole pieces. Advantageously, even at low frequencies in the 1,000 Hz to 15,000 Hz range, the mass of the field wiring prevents any audible noise. The maximum voltage overshoot and undershoot may be below ionization voltage, such as about 350 volts. The voltage and current rating of the freewheeling diode may be about equal to the rating of the IGBTs. The voltage rating may be at least 5 times the operating voltage, and more preferably at leas 10 times the operating voltage, to prevent damage from emergency shutdowns, lightning strikes and unusual events. The frequency may be high enough to provide a maximum change in exciter current during the PWM “on” time of no more than 10% and preferably less than 5%. The frequency is high enough to provide a maximum change in exciter current during the PWM “off” time of no more 10% and preferably less than 5%. The frequency may be high enough to provide a maximum change in exciter voltage during the PWM “on” time of no more than 10% and in some embodiments preferably less than 5%. The frequency may be high enough to provide a maximum change in exciter voltage during the PWM “off” time of no more 10% and preferably 5%. The system may operate at a frequency and PWM “on” time to produce greater than 10% savings in power at zero KVARS over conventional field DC power supplies.

It is desirable to have a PWM frequency at least ten (10) times the generated frequency, so the magnetic field is not seen on the final output voltage. For U.S. and Canadian systems, generation occurs at 60 Hz so the PWM frequency would be at least 600 Hz. For Europe and Asia, where generation typically occurs at 50 Hz, the PWM frequency would be at least 500 Hz.

In an exemplary inventive embodiment, DC field strength is controlled by using or employing pulse-width modulation having as sub-millisecond period and optionally is used to drive the field of a synchronous generator. The pulse-width modulation frequency may be from 500 to 30,000 Hz and the PWM “on” time may be no greater than 80%. The effective created current in the field may be from 50 to 1000 amps.

A method of controlling reactive power includes: measuring reactive power generated at a hydroelectric facility; and controlling DC field voltage by changing pulse-width-modulation having a sub-millisecond period. In one embodiment, a high frequency pulse-width modulated signal may be used to drive a magnetic field on or in a generator. In another embodiment, a high frequency pulse-width modulated signal may be used to control the field to a synchronous generator.

The invention relates to high frequency pulse width modulated excitation and methods of controlling reactive power in synchronous generators. The invention further relates to controlling direct current field voltage by changing pulse-width-modulation having a period in the sub-millisecond range. In addition, the invention relates to generator excitation at hydroelectric facilities.

### BRIEF DESCRIPTION OF THE DRAWING

Preferred features of the inventions are disclosed in the accompanying drawing, wherein:

FIG. 1 is a graph of magnetic field also known as flux density B as a function of field intensity H;

FIG. 2 is a circuit with two freewheeling diodes FWD with DC power PWM “on” (FWD₂ is closed);

FIG. 3 is a circuit with two freewheeling diodes FWD with DC power PWM “off” (FWD₂ is open);

FIG. 4 shows a single block with two IGBTs in one package, also known as a module, each module containing two IGBTs;

FIG. 5 shows a two single IGBTs in series;

FIG. 6 is a graph of magnetic field and field/power as a function of PWM frequency;

FIG. 7 is another graph of magnetic field and field/power as a function of PWM frequency;

FIG. 8 is a graph of magnetic field and power versus % “on” at 15 KHz;

FIG. 9 is a schematic of an embodiment of an electronic controller;

FIG. 10 is a graph of pulse width field-amps-time at 20,000 Hz for 10 μs “on,” 40 μs “off”;

FIG. 11 is another graph of pulse width field-amps-time at 20,000 Hz for 25 μs “on,” 25 μs “off”;

FIG. 12 is another graph of pulse width field-amps-time at 20,000 Hz for 40 μs “on,” 10 μs “off”; and

FIG. 13 is another graph of pulse width field-amps-time, in this example at 10-50 Hz for 40 μs “on,” 10 μs “off.”

### DETAILED DESCRIPTION OF THE PREFERRED EMBODIMENTS

Various materials may be used for generator exciters. However, sheet steel performs better than cast steel and cast iron. For sheet steel, the Field Intensity is higher than the other magnetic materials and it retains its magnetic field better when the current is removed. Generators fabricated in the early 1900s would have been formed of either sheet steel or cast steel. The advantage of sheet steel over cast steel is that the magnetic field can be higher and it increases more for the same current.

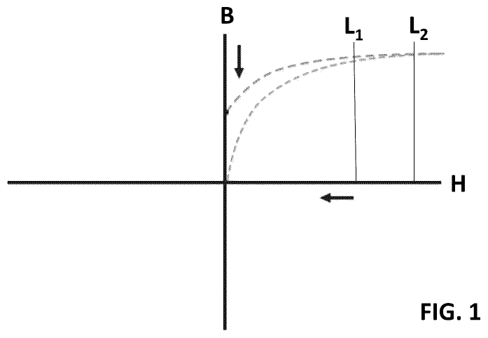

In one inventive embodiment, unexpectedly, it has been found that a permanent magnetic effect achieves power savings by rapidly switching the current on and off, with the magnetic field staying in place for a short period of time. As shown in FIG. 1, magnetic field also known as flux density B is plotted as a function of field intensity H. This is proportional to the DC current flowing through the coils on an electromagnet. An electromagnet is the same as the field coils in synchronous generators used in most hydroelectric generators. As the amount of current increases, the magnetic field increases. The magnetic field will remain constant for any given current. In typical applications, PWM is used to produce magnetic fields that are used to extract energy, e.g., power electric motors. Unexpectedly and advantageously, unlike in the prior art, PWM is used in the inventive embodiment to produce magnetic fields where no energy is extracted except at low frequencies such as 500 Hz and low power. Unexpectedly and advantageously, energy savings thus may be realized with PWM. FIG. 1 shows magnetic hysteresis.

Due to the retentivity of the material, there remains a magnetic flux with no applied force (no current through the coil). The electromagnet core acts as a permanent magnet for a short period of time. It would be expected that the same amount of current would be used as standard exciters that use constant current (amps). However, unexpectedly, about 30% to about 50% less energy is used by the inventive system implementing PWM.

In the graph of FIG. 1, if one turns on and off the current between the vertical lines L₁ and L₂, the magnetic field remains almost constant. The only loss is the hysteresis loss and I squared times resistance loss. If the coils were superconductors with no electrical resistance, the magnetic field would require no energy except the energy required to first start the current flowing. Also, if the field was a permanent magnet, then no energy would be required except for that required to create the magnet in the first place. This is why almost all electric vehicles (EV) use motors with permanent magnets for the fields.

If the current is off for too long, then the magnetic field goes to zero and more energy is required to reestablish the field. Also, the hysteresis energy greatly increases as the time “off” increases.

On typical generators in the 50 0KW to 2,000 KW range, it has been found that the energy savings is best at frequencies above 1,000 Hz and decreases slightly from 5,000 Hz to 30,000 Hz. The slight decrease in efficiency is due to switching losses in the IGBTs used for PWM. If the PWM frequency is too slow, efficiency is lost as the “permanent magnet effect” is lost. In an exemplary, preferred embodiment, the frequency is above 2,000 Hz. Below 500 Hz, the advantages have been found to be less pronounced.

If the percent of “on” time is too high, the “permanent magnet effect” is lost. In an exemplary embodiment, the preferred maximum “on” time is below 70%. It has been found that there is almost no advantage above 90%.

The percent “on” time is controlled by voltage. As the supply DC voltage to the IGBT is increased, the percent “on” time decreases. If the voltage is too high, then the percent “on” time is very low and it is difficult to control the magnetic field. Preferably, the voltage is low enough to provide at least 50% “on” time and not so high that the “on” time is below 20% at typical operating conditions. Also, in a preferred embodiment, the frequency is maintained above the range that people can hear, which typically is above 15,000 Hz.

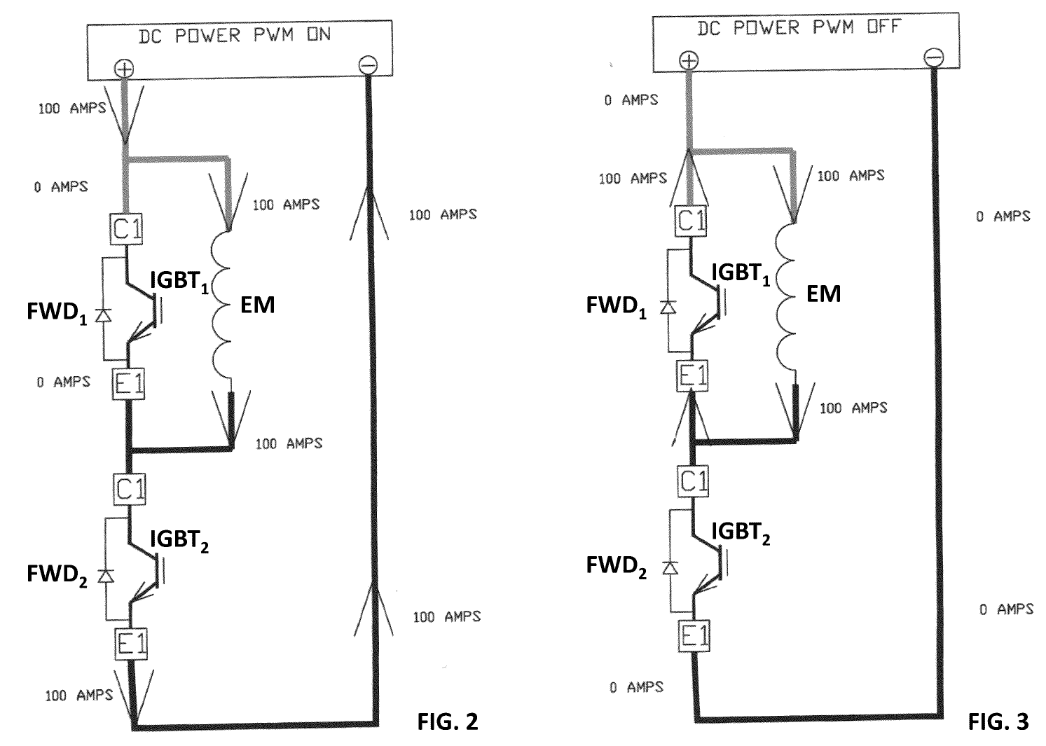

Turning to FIG. 2 and FIG. 3, there is shown a circuit with two freewheeling diodes FWD (also sometimes known as snubber diodes, suppressor diodes, catch diodes, clamp diodes, and commutating diodes), with DC power PWM “on” (FWD₂ is closed) and DC power PWM “off” (FWD₂ is open), respectively. An electromagnet EM, for example a single coil 8-10 feet in diameter and rotating, provides the magnetic field for the generator. IGBT modules, for example, may be Infineon FZ3600R12HP4 IGBT modules with specifications V_{CES}=1200V, I_{C nom}=3600 A/I_{CRM}−7200 A, Eₒₙ=485 mJ (to turn on) and E_{off}=810 mJ (to turn off) at 25° C., t_{d on} (turn on time)=0.44 μs and t_{d off} (turn off time)=1.15 μs at 25° C.

The use of IGBTs (typically utilized in wind and solar applications) combined with freewheeling diodes offers advantages over the prior art including frequency operation preferably from about 2,000 to about 30,000 Hz, making it possible to match the frequency to virtually all exciters, open software allowing direct use with AB PLCs or all brands of PLCs, substantial cost reduction (e.g., from about $3,000 to about $400), much higher operating currents and much higher operating voltages, and essentially ready availability because the IGBTs are mass produced. Examples of IGBTs for the inventive embodiments include: Infineon #FF1400R17 (1400 amps at 1700 volts); Infineon #FF1800R17 (1800 amps at 1700 volts); Mitsubishi electric CM800DZ-34H (800 amps 1700 volts); and Mitsubishi electric CM1200DZ-34H (1200 amps at 1700 volts).

Mitsubishi groups its HVIGBT modules circuit topologies into three types: Single type (H); Dual type (D), and Chopper type (E2 or E4). See HVIGBT Module Application Note, Mitsubishi Electric, HVM-0021 (December 2022), at 3, and the entire contents of this Application Note are incorporated herein by reference.

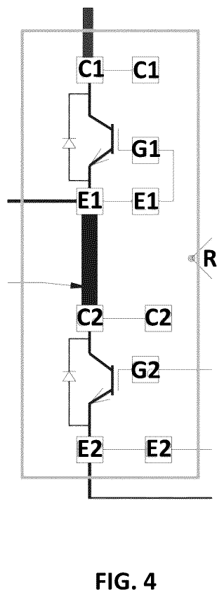

FIG. 4 shows another circuit with dual IGBTs. In one exemplary embodiment, two individual units are used while in another exemplary embodiment, two IGBTs are disposed in one assembly. Two IGBTs are provided with the emitter of the first (E1) connected to the collector of the second (C2). IGBT 1 is permanently switched off by connecting E1 to G1. IGBT 2 is switched on and off at a frequency of from 500 Hz to 30,000 Hz. The exciter coils are connected between C1 and E1. The supply voltage across C1 and E2 must be high enough so that the “on” time is never more than 80% and thus the off time at least 20%. Preferably, the “on” time is from 20% to 60%. The current through IGBT 1 will only be through the diode and the current through IGBT 2 must be no higher than 75% of the current through the IGBT 1 diode. Preferably, 20% to 60% of the current is through IGBT 1. Those skilled in the art will recognize that the exciter coil may be connected across IGBT 2 and IGBT 2 permanently switched off. IGBT 1 becomes the switched IGBT. Reverse use of the dual IGBTs also may be achieved. IGBTs may be used in parallel to obtain higher currents. A dual IGBT module has an unswitched IGBT and a switched IGBT connected in series with each other

One skilled in the art would recognize that two single IGBT H-modules could be combined to form an equivalent, dual IGBT module.

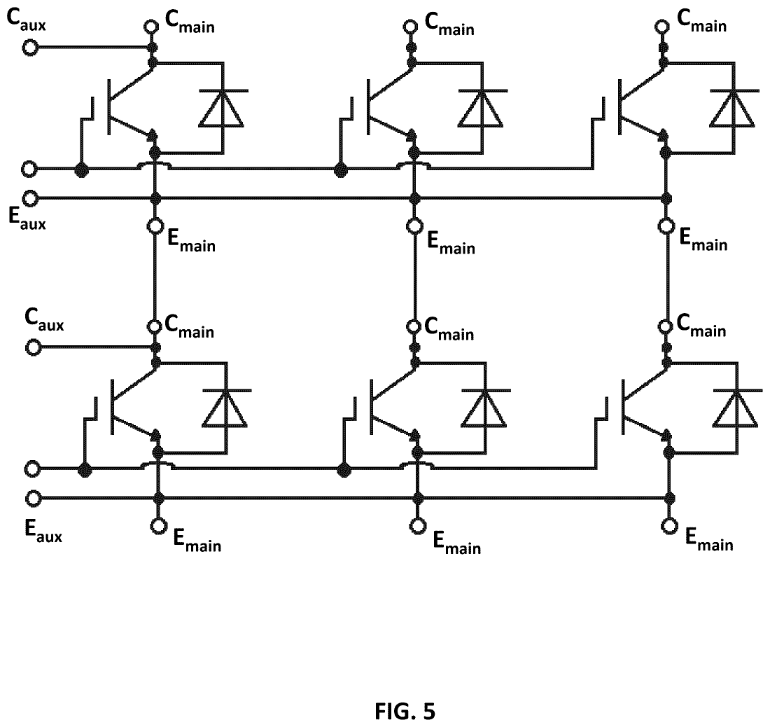

FIG. 5 shows two (2) single IGBTs (H) in series. With two single IGBT modules connected in series, the first module is an unswitched IGBT and the second module is a switched IGBT, the unswitched IGBT and the switched IGBT being connected in series with each other. Here, Cₐᵤₓ represents an auxiliary terminal, Cₘₐᵢₙ represents a main terminal coming into the unit, Eₐᵤₓ represents a contact, and Eₘₐᵢₙ represents a main terminal coming out of the unit.

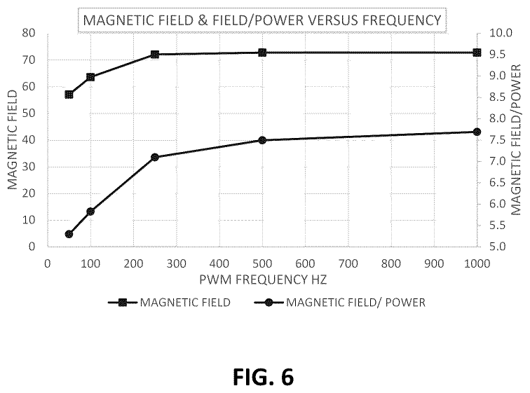

FIG. 6 shows a plot of magnetic field and field/power versus frequency for testing from 50 Hz to 1000 Hz at 60% “on” and 40% “off” for the IGBT Module (testing with 3.4 CM1200). It is important to have a constant magnetic field as well as the maximum field for the least power. The graph clearly shows a large drop off in the magnetic field below 250 Hz and significant drop below 500 Hz. Preferably, from the data plotted in FIG. 6, the exemplary inventive embodiment is operated above 500 Hz.

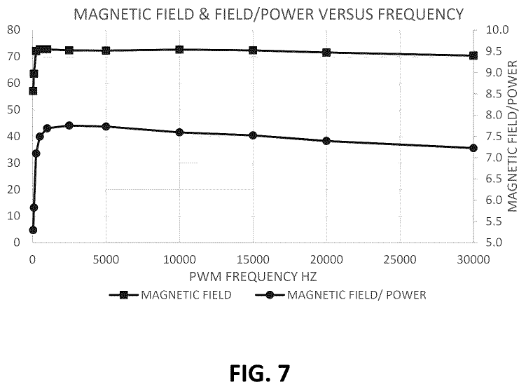

FIG. 7 shows a plot of magnetic field and field/power versus frequency for testing from 50 Hz to 30,000 Hz. As frequency increases, some energy is lost as the IGBT consumes energy every switching cycle. Preferably, from the data plotted in FIG. 7, the exemplary inventive embodiment is operated 2500 to 20,000 Hz. Preferably, noise created in the human hearing range is avoided during operation, and thus from the data plotted in FIG. 7, the exemplary inventive embodiment is operated in the 15,000 to 30,000 Hz range.

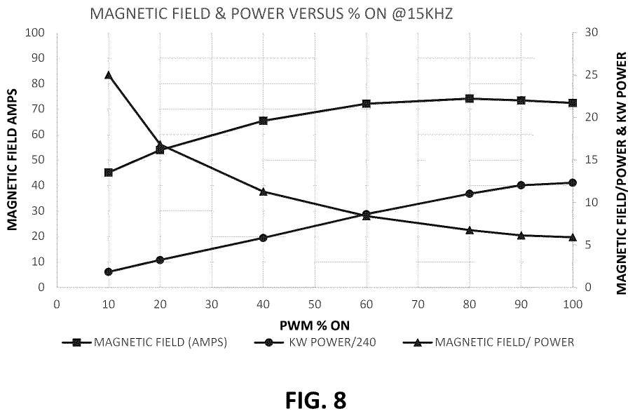

Another important aspect of using PWM is to achieve maximum magnetic field at the lowest power input. Hydroelectric generators require a magnetic field that provides the correct voltage and power factor or KVARS. In most cases, it is desirable to operate at 0 KVARS. In other cases, it may be desirable to operate below or above 0 KVARS. From testing, it unexpectedly has been found that to achieve maximum magnetic field, it is best to operate the IGBTs at below 80% “on” or 20% “off.” Below about 40% “on,” the magnetic field is weak. Above 60%, the magnetic field remains almost constant as the % “on” is increased. However, the power continues to increase as the % “on” increases. Thus, power is wasted. In an exemplary inventive embodiment, operating below about 70% is preferred because of the energy savings as shown in FIG. 8, magnetic field and power versus % “on” at 15 KHz. At 100% “on,” the IGBT is equivalent to conventional exciters where voltage is controlled. The same magnetic field is provided for about 50% less power at 50% “on” versus pure DC 100% “on.” This is a totally unexpected finding.

This is further be demonstrated by looking at the current to the magnetic field coils versus frequency on an oscilloscope capable of microsecond resolution. The oscilloscope plots current and voltage versus time across the exciter coils (e.g., for a motor used for testing). When the voltage is “off” for 4 divisions and “on” for 6 divisions, the current remains on continuously even when the voltage is off. The voltage goes negative by about an amount equal to the positive voltage when the IGBT switches off. Then, the current remains essentially constant during the “off” period. During the “off” period, the voltage across the exciter is about 20 volts positive. This is the voltage drop across the freewheeling diode. It is important that the current remains constant as the magnetic field is the current times the number of windings. At 2500 Hz and above, the current (magnetic field) remains constant even when the voltage is off. At 500 Hz, the current is no longer constant during the on and off periods. The current increases slowly when the IGBT switches on and decreases during the off period. As the frequency decreases, the change in current becomes much more prominent at 250 Hz. The voltage also becomes much more variable. This is very undesirable. Even at 1000 Hz, the change in voltage and current is evident.

At 15,000 Hz, the voltage and current are essentially stable during the “on” and “off” periods, except for momentary spikes during the switching and lasting for only 1 to 2 μs. There is a constant reverse voltage during the “off” period.

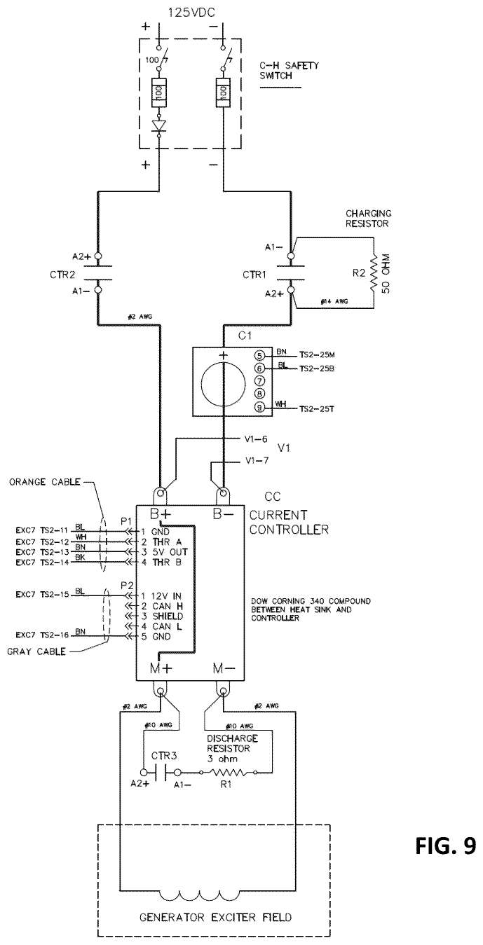

In one embodiment, as shown schematically in FIG. 9, an MC600C DC motor controller manufactured by Zero Emission Vehicles Australia (ZEVA) designated CC is installed in series between the DC bus and generator field windings. While designed to be a motor controller for electric vehicles, solid state motor controller CC advantageously provides desirable features for use in hydroelectric facilities. Among the features is silent operation and high efficiency due to the use of power semiconductor devices as well as an industry-standard Controller Area Network (CAN) bus interface permitting remote monitoring of the controller's status and statistics not to mention reprogramming of operating parameters. The controller also includes fully-isolated logic and power circuits as well as independent hardware overcurrent detection (so-called desaturation detection). Solid state motor controller CC operates at a switching frequency of 16 kHz, a maximum current of 600 A (1 minute), and a continuous current of 200 A. Advantageously, controller CC has a relatively low cost at only about $1,300, whereas other commercially available exciter controllers not specifically designed for electric vehicles are substantially more expensive. In alternate embodiments, DC motor “WarP-Drive controllers” commercially available from Netgain Controls, Inc. (Logan, UT) or “Zilla” motor controllers available from Manzanita Micro (Kingston, WA) similarly may be used.

Additional components shown schematically in FIG. 9 include: a split core DC current transducer, 0-150 amps, designated C1 and manufactured by CR Magnetics, part no. CR5220S-150; contactors, each a 24V coil with Aux NO contact, designated CTR1 and CTR2 and manufactured by GigaVac, part no. GX23CCB; a contactor, latching, 24V coils with NO Aux, designated CTR3 and manufactured by Giga Vac, part no. GXL14C1CB; a planar resistor, 3 ohm, 600 watt, designated R1 and manufactured by Ohmite, part no. TAP600K3ROE; a resistor, 50 ohm, 160 watt, designated R2 and manufactured by Ohmite, part no. WFH160L5ORJE; and a transducer, 0-600 VDC in, 4-20 mA, designated V1 and manufactured by Ohio Semitronics, part no. DVT7E.

In one experiment, a prototype system was installed at a 2 MW hydropower plant. The prototype system utilized controller CC (an MC600C DC motor controller) with an existing dirty (e.g., having a large amount of AC wave form), nominal 125 VDC bus from a three phase thyristor-controlled diode system for the generators at the facility. Unexpectedly, a diode had to be installed between the controller CC and the existing DC bus to prevent controller CC from sending back a large amount of DC from its internal capacitors. Unexpectedly and advantageously, the prototype system achieved much lower power of 44% for full generator output, reduction of power from about 80 amps to 60 amps at 125 volts, very good control of field at lower power for initial voltage and RPM control for synchronization, easy and precise control of KVARS (e.g., good repeatability from preset output), and no audible noise or harmonic. Higher generator output also may have been achieved.

In another experiment, a prototype system was installed at a 1.5 MW generator at a hydropower plant. The challenge with this generator was that the previous exciter current was at 110 A at 125 V, or in terms of power 13.75 KW. A concern was that the prototype would not achieve sufficient power.

With a rheostat, power is wasted in its internal resistance. However, DC amps is expected to be the same in all cases as the magnetic field is proportional to the current (amps) times the number of turns of wire in the field. In other words, the number of turns of wire in the field cannot change.

Unexpectedly, about zero KVARS was achieved at a current of only 68 A with a voltage of 91 V, or in terms of power about 6.2 KW. The power input was confirmed by measuring the input AC power to the prototype exciter system at 17.1 A at 200 V AC, or 17.0×1.732×202 volts for about 5.9 KW. Theoretically, the AC input would be expected to be about 2% higher than output due to diode and transformer losses, and thus the difference may have been due to measuring accuracy of the meters that were used.

Unexpectedly, at least a 30% lower amperage input was experienced with the prototype exciter system. About 30% of the roughly 13,750 watts could be explained by loss in the rheostat, wasted as I²R loss.

Another factor is that the peak amps 17,000 times per second is about 93 amps derived by measuring steady state amps into the prototype controller with the controller on 73% of the time. Thus, peak current may be estimated as the average current in divided by the percent on time, or 68/.73 which is 93 peak amps 17,000 time per second.

Advantageously, the prototype controller system using controller CC saved exciter power. Moreover, advantageously, the system employed a programmable logic controller (PLC) for automation. Still further, maintenance savings were achieved by eliminating the need for rheostat brush replacements. Higher generator output (KW) also may have been achieved.

In sum, advantageously, advances in efficiency and lowering of costs associated with control systems for electric vehicles has unexpectedly provided opportunities to implement the low cost controllers used for electric vehicles instead in the context of hydroelectric generator excitation. Among the advantages, the high frequency controllers for DC motors change motor speed and torque with high frequency (10,000 to 30,000 pulses of direct current) with almost perfect square wave form. The frequency is above that where the magnetic field can collapse between pulses and thus the efficiency is very high. Also, the components of the system do not produce audible noise (and such noise otherwise is a persistent problem in hydroelectric plants). The high frequency controllers also utilize a an Ethernet bus that provides all of the information needed to fully automate the controller into a hydroelectric facility. Importantly, safety controls are built into these controllers because of their mainstream use in vehicles, and those safety features are well-suited to the safety needs of hydroelectric facilities. Those safety needs include: (1) that when turned on, the output must be essentially zero (in cars to prevent runaway at startup, while in hydroelectric applications to prevent excessive excitation when the generator is not turning); (2) overtemperature/overcurrent operation (the controllers automatically reduce their output if a problem in temperature or overcurrent is sensed); (3) the controllers include built-in safety features to prevent either overvoltage or undervoltage; and (4) the controllers allow for precise and repeatable settings. Another advantage of using the high frequency controllers in hydroelectric plants is that the voltage and current ratings match those needed for typical small and medium hydroelectric facilities. In addition, because the controllers are designed for cars, they are low in weight, small in size, and do not generate excessive heat. While weight is not particularly important in the hydropower application, the controller size and heat management are very important as the space is limited and the controller must able to operate in hot environments similar to temperatures experienced with a car.

The system and method disclosed herein addresses the need to replace legacy systems that employ rheostats. Problematically, a DC power source (i.e., a rectifier taking AC and making it DC, or a motor generator set (MG set) which uses an AC motor to produce DC current) provides DC at a particular voltage that cannot be adjusted, so it does not allow one to synchronize or adjust reactive power at a hydroelectric facility. As explained, this problem is typically addressed by using a large rheostat (an adjustable resistor) which allows the resistance to be adjusted so as to adjust how much current flows through. While changing the resistance changes the current flow, the rheostat is incredibly wasteful because it requires passing power through a resistor to get a voltage drop, so there is a power loss measured by P=I²R. Alternatively, on larger, more modern generators, three-phase AC power is taken in, and then rectified to obtain DC, turned on and off with a silicon controlled rectifier (SCR) to adjust to adjust the output DC voltage and hence the steady amps to the field.

Using a pulse-width modulation, SCR turns off when voltage is zero; thus, if it is desired to have 50% turn on at the peak of a sine wave. At most, this happens at 180 Hz (three-phase at 60 Hz—three sine waves). If it is desired to have 25% power, each sine wave would be turned “on” for 25% of the time, such that there would be three pulses in 1/60 second.

Importantly, the prior art systems cannot respond to fluctuations faster than 1/180 of a second.

An electromagnet is created by wrapping a coil around metal poles and then have DC current flowing. It is desired to control the DC current for various reasons before the generator is connected to the grid to be synchronized with the grid. By changing the DC current to the field the generator output voltage is changed so it matches the voltage of the interconnecting grid. In order to synchronize to the grid, the voltage at the generator terminals needs to be matched with the voltage of the interconnection to the grid. The more current, the stronger the magnetic field, and the stronger the voltage out of the generator. Once synchronized/connected to the grid, that voltage cannot be changed because the hydroelectric plant's generator is one of thousands of sources connected to the grid.

If the current is changed, then the reactive power that is produced is also changed. The generator essentially becomes a giant capacitor or giant inductor by adjusting the DC current (the DC excitation). Exciting means making a magnetic field; the more DC current that is delivered, the more reactive power is produced, while the lower the DC current, the greater the reactive power that is consumed. If set at no reactive power, and if excitation is increased, then reactive power is generated. But if excitation is reduced, reactive power is consumed. Both are used to stabilize voltage on the grid, so the ability to change the DC field quickly and easily permits stabilization of voltage on the grid.

Preferably, an incoming power source is provided with between 0% and 10% amplitude variation—such as by using a commercial fork lift battery charger (70-90 volts, 100-200 amps supply) like a golf cart battery charger (which does not need a diode).

In some embodiments, if the voltage variation is greater than 10% of the AC ripple, then a diode is used to prevent large in-rushes so that capacitors in the exciter controller do not back-feed to the power supply.

In some embodiments, a reactance to frequency ratio is achieved between 0.1 and 0.9.

Advantageously, as discussed above, the controller CC operates at a switching frequency of 16 kHz rather than 180 Hz. This difference, of about two orders of magnitude faster, allowing effectively instantaneous response to fluctuations in grid voltage. Such a solution previously was very expensive. And unexpectedly, using electric vehicle motor controllers (permitting variable DC power supplies to drive motors), the controllers drive the motors fast at 16 kHz and there is minimal audible noise associated with the controller operation. By comparison, a hum certainly can be heard from a 60 Hz transformer. At a frequency 16 kHz, the audible noise is minimized for electric vehicles but advantageously in hydroelectric plants as well. Unexpectedly, power consumption (power loss) when using a high frequency controller is significantly lower, related to the frequency versus reactance of the generator.

Advantageously, in some embodiments, the generated reactive power may be measured and the DC field may be controlled. Specifically, the generated reactive power may be measured and the pulse-width-modulation may be changed on a sub-millisecond basis.

Advantageously, a high frequency pulse-width modulated signal may be used to drive a synchronous generator (i.e., to create the magnetic field in a synchronous generator), which thereby permits a sub-millisecond response time as well as concomitant reduction in lost power.

If voltage out of power supply (which is a rectifier which takes AC in and flips the negative half up) has a ripple (not perfect DC), then a diode can be employed.

Advantageously, using a high frequency pulse and specific shape (a square wave versus a sine wave) facilitates better control of responsiveness/timing. For example, if only 1% of a sine wave is desired then timing is critical, but with a square wave the timing is linear so the precision needed in timing does not change with the percentage power that is desired to be delivered. Thus, if it is desired to deliver power at a particular precision, the timing of the pulse is important; a sine wave is harder to use to achieve precision, particularly at low outputs or high outputs—at either end of the sine wave it becomes a challenge.

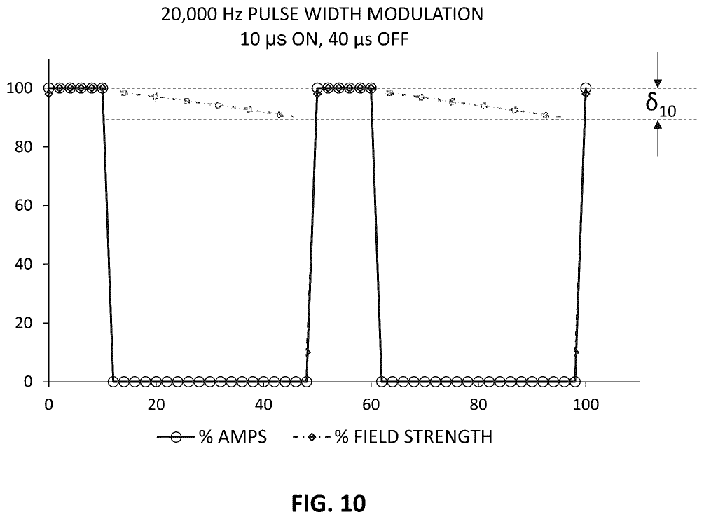

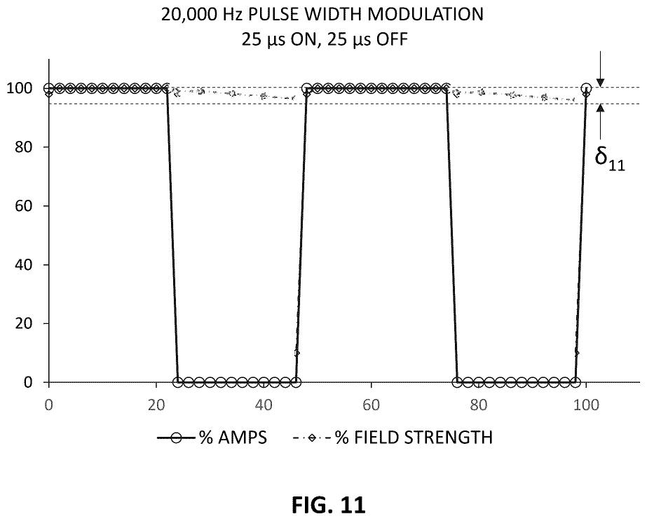

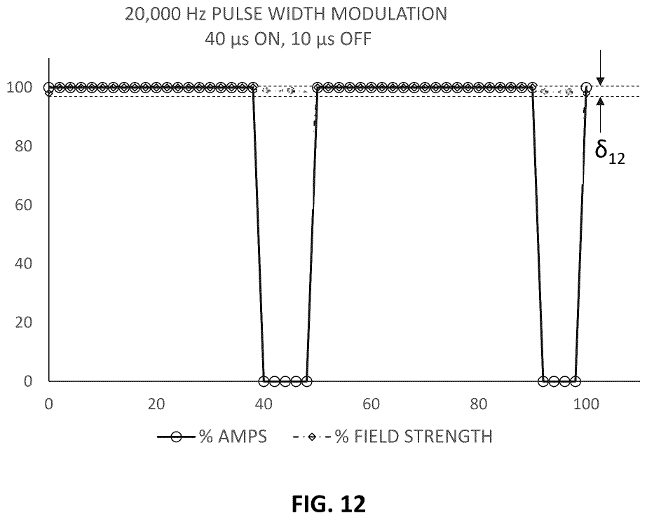

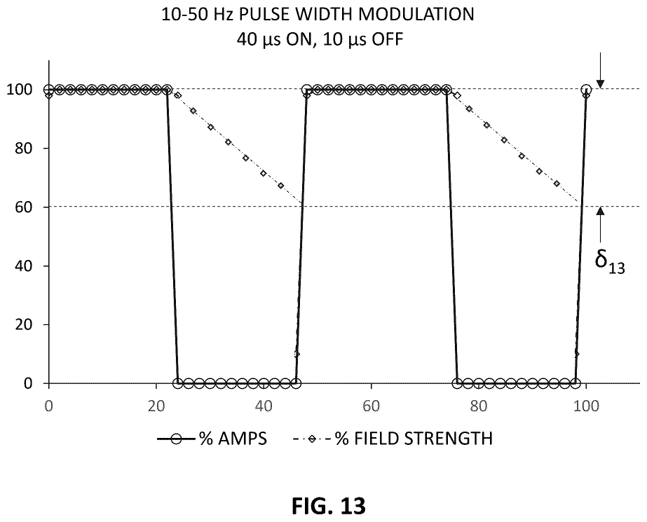

FIGS. 10-12 are exemplary charts with varying outputs for a 20,000 Hz system. FIG. 13 is a chart with output for a 10-50 Hz system. When switching “on,” both amps and field strength are at 100%. When switching “off” occurs, amps drops to zero percent but it is desired that the field strength stays as constant as possible, in the ideal case at 100%. Further, when switching “off” occurs, there may be an acceptable range of drop off for the field strength, e.g., no more than 20% in an exemplary embodiment, and more preferably no more than 10% from when switching was “on,” and minimizing the drop off is desired. Turning to FIG. 10, the drop off in field strength δ₁₀ is 10%. In FIG. 11, the drop off in field strength δ₁₁ is 5.625%. And in FIG. 12, the drop off in field strength δ₁₂ is just 2.5%. FIGS. 10-12 show acceptable results, e.g., at higher frequency and when the field strength does not have time to substantially collapse during the short “off” times. By comparison, in FIG. 13, the drop off in field strength δ₁₃ is 40%. In this example, the frequency is so low that the field strength drops off dramatically even in the short time for switched “off”. Such a substantial field strength collapse is highly undesirable.

The production units manufactured for automobiles are limited in frequency to between 14,000 and 20,000 Hz. The higher frequency provides higher efficiencies.

There are numerous prior art systems with PWM for generators typically at 1,000 Hz. The exemplary inventive embodiment is unique in that it operates at high frequency (2 KHz to 20 KHz), which reduces switching losses, and uses automotive PWM systems. It is not obvious to use these for this purpose and limits of amps for excitation from 50 to 500 amps and voltages in the range of 50 to 350 volts DC, which have been mass produced for automotive use in the past decade at low cost and small size and designed for automotive applications (similar to old hydro generator environments).

For the several thousand old generators installed in hydroelectric plants in the 1900s, the inventive embodiments offer a significant advantage.

Also, the automotive technology limits excitation for generators in the range of 50 KW to 2 MW and at most 4 MW. Excitation power coincides with the need for automotive energy required for the motors, typically 5 KW or more, continuous. (The automotive units can provide short spurts of 10 times this for 10 seconds.) However, excitation requirements do not need spurts, but rather only steady state. Nevertheless, the automotive units satisfy the requirements for hydroelectric generators including power, voltage, amps, cooling, control, and size.

It should be noted that the higher frequency provides higher efficiency, because the magnetic dipoles cannot fully reverse when the current is off. This is important only when the magnetic field magnetic material, typically iron or steel, has a large mass, e.g., 500 to 10,000 lbs.

Another important parameter is that the PWM frequency should be at least 100 times the generating frequency, so that the PWM frequency does not show up on the power produced. Thus, for a generating frequency of 60 Hz, preferably the PWM frequency is at least 6,000 Hz (a factor of 100) or 12,000 Hz (a factor of 200).

In another exemplary embodiment, exciters comprising IGBTs rated 50 to 3600 Amps are used, such as INFINEON FZ3600R17HP4 modules with Trench/Fieldstop IGBT4 and Emitter Controlled diodes. In one embodiment, two such IGBTs are required, one acting as a diode and one acting as a switch. Preferably, the IGBTs are rated at 3600 amps at 1700 volts. In this embodiment, Snubbing Metalized Film Capacitors manufactured by Kemet, or equivalent, for example Kemet model no C44U, 2000 uf to 10,000 Uf at 600 to 1700 volts, are required for low frequency damping of equal to or more than 4 Volts/micro seconds. In addition, Snubbing Metalized Capacitors manufactured by Cornell Dublier, or equivalent, for example Cornell Dublier model no. SCD205K102D3Z25-F, 4 to 50 uf at 600 volts to 1700 volts, are required for high frequency damping equal to or greater than 300 volts/microseconds, more preferably at least 500 volts/microsecond. Preferably, the Cornell Dublier capacitors have a rating of at least 50 amps rms at 10,000 hertz. Preferably, the Kemet capacitors have a rating of at least 15 amps ripple current at 100,000 hertz.

The capacitors may be combined in multiples to meet certain minimum requirements. For example, typically, 3 of each type (Cornell Dublier; Kemet) must be employed to minimize the voltage spikes during turn on and off. In one experiment, operation at 13,980 hertz had a positive spike at 148 volts upon turn on and negative spike at −150 volts upon turn off. This is with five 1100 uf capacitors with a combined capacitance of 5,500 uf using Kenmet C44 type capacitors and five 2 uf capacitors with a combined capacitance of 10 uf using Cornell Dublier SCD type capacitors. The exciter impedance and amperage required changes the voltage spikes; the higher the impedance (the more turns of wires), the higher the voltage spike and the higher the amperage, the higher the voltage spike, and the faster the turn on or turn off, the higher the spikes. Thus, the capacitors must be sized so that the turn on voltage never exceeds the running voltage by more than 2× and the turn off negative voltage spike never exceeds 3× the operating voltage.

Preferably, the slow capacitor (Kemet C44) must be rated so that the total Amperage root-mean-square (A-rms) at 10 Khz is at least equal the maximum desired DC output amps. More preferably, the total A-rms at 10Khz is two times the maximum desired DC output amps (as a safety factor). Thus, a system rated for 400 amps must have at least 5 Kemet C44UOGT7110T52K capacitors rated 81 amps each.

Preferably, the fast capacitor (Cornell Dublier SCD IGBT) must be rated so that the combined capacitors must be rated for current root-mean-square) Iₘₛ at 100 khz at preferably 1.0 and minimum of 0.4 times the total de current and have a combined current peak of at least 3 times the rated current. For example, the SCD205K102D3Z25-F is rated 26.2 Iᵣₘₛ and 800 peak amps. Thus, for 400 amps, 6 capacitors are required. The switching time of each capacitor must be at least equal and preferably four times the IGBT switching time of 100 volts/microsecond. In this example, there is 400 volts/microsecond for this capacitor or 4 times the IGBT switching time.

Additional capacitors may be used because there is no disadvantage to excess capacitance. However, such additional capacitors add cost and space.

In yet another embodiment, IGBTs are used that have lower switching losses and higher amp rating in smaller packages. In one preferred example, Infineon FF1800XTR17T2P5 XHP™2 modules with Trench/Fieldstop IGBT5, emitter controlled 5 diode and NTC are used. The on and off switching losses and collector-to-emitter voltage drop are substantially improved.

The on and off switching energy lowers from 360 microjoules per pulse to 330 microjoules per pulse and the collector-to-emitter voltage decreases from 2.15 to 1.75 volts at 1200 amps between successive IGBT generations.

While various descriptions of the inventions are described above, it should be understood that the various features can be used singly or in any combination thereof. Therefore, the inventions are not to be limited to only the specifically preferred embodiments depicted or otherwise described herein.

Further, it should be understood that variations and modifications within the spirit and scope of the inventions may occur to those skilled in the art to which the inventions pertain. Accordingly, all expedient modifications readily attainable by one versed in the art from the disclosure set forth herein that are within the scope and spirit of the inventions are to be included as further embodiments of the inventions. The scope of the inventions is accordingly defined as set forth in the appended claims.

1. A method of controlling synchronous generator exciter magnetic fields at a hydroelectric facility comprising:
controlling field strength of a generator exciter by using pulse-width-modulation with at least one dual IGBT module selected from the group consisting of:
(i) a dual IGBT module comprising an unswitched IGBT and a switched IGBT connected in series with each other: and
(ii) two single IGBT modules connected in series, the first module comprising an unswitched IGBT and the second module comprising a switched IGBT, the unswitched IGBT and the switched IGBT connected in series with each other:
wherein a single IGBT module is selected from the group consisting of: (i) two single IGBT modules, (ii) two double IGBT modules, (iii) two triple IGBT modules, and (iv) a single dual IGBT module;
wherein each unswitched and switched IGBT comprises a collector, an emitter, and a gate:
wherein a pulse-width modulator supplies switching voltage to the gate:
wherein each unswitched and switched IGBT is connected in parallel with a freewheeling diode:
wherein each IGBT module has a sub-millisecond period, an on-off switching time and an off-on switching time each being no more than 10 μs, and a PWM frequency of 100 Hz to 30,000 Hz;
wherein the generator exciter is supplied with a total current of at least 50 A from the at least one dual IGBT module.

2. The method of claim 1, wherein the PWM frequency is sufficient such that during an off time thereof, a magnetic field of the generator exciter does not drop more than 20%.

3. (canceled)

4. The method of claim 1, wherein the PWM frequency is sufficient such that during an on time thereof, a magnetic field of the generator exciter does not increase more than 20%.

5. (canceled)

6. (canceled)

7. The method of claim 1, wherein a gate signal from the pulse-width modulator to the switched IGBT has a gate-to-emitter voltage between 8 V and 20 V and the gate signal supplies 0.5 A to 20 A between the gate and the emitter at a frequency of 500 to 30,000 Hz.

8. (canceled)

9. The method of claim 1, wherein the gate of the unswitched IGBT is shorted to the emitter thereof to prevent switching.

10. The method of claim 1, wherein a high frequency pulse-width modulated current is used to drive a magnetic field of the generator exciter.

11. The method of claim 1, wherein the frequency range of the pulse-width modulation is from 500 Hz to 30,000 Hz.

12. The method of claim 1, wherein pulse-width modulated on time is from 20% to 80%.

13. The method of claim 1, wherein the exciter current is from 50 to 500 amps.

14. The method of claim 1, wherein the exciter voltage is between 50 and 500 volts.

15. The method of claim 1, wherein the output of the generator is from 0.1 MW to 50 MW.

16. (canceled)

17. (canceled)

18. (canceled)

19. The method of claim 1, wherein the pulse-width modulation frequency is above audible range for humans.

20. (canceled)

21. (canceled)

22. The method of claim 1, wherein maximum voltage overshoot and undershoot is below ionization voltage.

23. (canceled)

24. (canceled)

25. The method of claim 1, wherein the voltage and current rating of the freewheeling diode is about equal to the rating of the IGBTs.

26. (canceled)

27. (canceled)

28. The method of claim 1, wherein the frequency of the pulse-width modulation is sufficient to provide a maximum change in exciter current during the pulse-width modulation on time of no more than 10%.

29. (canceled)

30. The method of claim 1, wherein the frequency of the pulse-width modulation is sufficient to provide a maximum change in exciter current during the pulse-width modulation off time of no more than 10%.

31. (canceled)

32. A method of controlling synchronous generator exciter magnetic fields at a hydroelectric facility comprising:
controlling field strength of a generator exciter by using pulse-width-modulation with at least one IGBT module selected from the group consisting of:
(i) a dual switch, half-bridge IGBT module comprising an unswitched IGBT and a switched IGBT in series: and
(ii) two IGBT modules connected in series to form a half-bridge, the first module comprising an unswitched IGBT and the second module comprising a switched IGBT, each unswitched and switched IGBT connected in parallel with a freewheeling diode;
wherein each unswitched and switched IGBT comprises a collector, an emitter, and a gate:
wherein each unswitched and switched IGBT is connected in parallel with a freewheeling diode;
wherein the frequency of pulse-width modulation is sufficient to provide a maximum change in exciter current during each of PWM on and PWM off time of no more than 10%.

33. The method of claim 32, wherein the frequency of pulse-width modulation is sufficient to provide a maximum change in exciter current during each of the PWM on and PWM off time of no more than 5%.

34. The method of claim 32, wherein the frequency of pulse-width modulation is sufficient to provide a maximum change in generator exciter current during the PWM on time of no more than 10%.

35. (canceled)

36. (canceled)

37. The method of claim 32, wherein the frequency of pulse-width modulation is sufficient to provide a maximum change in generator exciter current during the PWM off time of no more 10%.

38. (canceled)

39. (canceled)

40. The method of claim 32, wherein pulse-width modulation current is operating at a frequency and PWM on time to produce at least 10% savings in power at zero KVARS phase angle thyristor or time fired thyristor exciter controllers operating at 50 A to 500 A.

41. A controller for a hydroelectric facility for controlling synchronous generator exciter field strength comprising:
at least one IGBT module selected from the group consisting of:
(i) a dual switch, half-bridge IGBT module comprising an unswitched IGBT and a switched IGBT in series; and
(ii) two IGBT modules connected in series to form a half-bridge, the first module comprising an unswitched IGBT and the second module comprising a switched IGBT, each unswitched and switched IGBT connected in parallel with a freewheeling diode;
wherein each unswitched and switched IGBT is connected in parallel with a freewheeling diode;
a pulse-width generator that provides a pulse width frequency and pulse width modulation percent on signal,
wherein the pulse width modulation percent on signal has a frequency of 500 Hz to 30,000 Hz and switches the switched IGBT of the at least one IGBT module.
